(19) United States
(12) Patent Application Publication
(10) Pub. No.: US 2009/0024418 A1
(43) Pub. Date: Jan. 22, 2009

(54) SYSTEMS FOR GENERATING RADIOLOGY REPORTS

(76) Inventor: Jeffrey Yu, Honolulu, HI (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/178,560

(22) Filed: Jul. 23, 2008

Related U.S. Application Data
(63) Continuation of application No. 09/922,390, filed on Aug. 2, 2001, now abandoned.
(60) Provisional application No. 60/289,904, filed on May 9, 2001.

(51) Int. Cl. G06Q 50/00; G06F 19/00; G06Q 30/00

(52) U.S. Cl. 705/3; 705/34

(57) ABSTRACT

A method of generating a patient report, comprising: presenting an operator with an on screen menu of standardized types of reports; having the operator select a standardized type of report from the on screen menu of standardized types of reports; presenting the operator with an on screen organ list corresponding to the selected standardized type of report; for each organ, presenting the operator with a menu of standard medical descriptions corresponding to the organ; having the operator determine a medical description corresponding to each organ; and outputting a patient report describing the medical description of each organ.

### CROSS-REFERENCES TO RELATED APPLICATIONS

This application is a continuation of U.S. application Ser. No. 09/922,390, filed Aug. 2, 2001, which claims the benefit of U.S. Provisional Application No. 60/289,904, filed May 9, 2001. The foregoing applications are hereby incorporated by reference in their entirety.

### BACKGROUND OF THE INVENTION

(a) Technical Field

The present invention relates to systems for organizing and generating medical reports in general, and to systems for organizing and generating radiology reports in particular.

(b) Background

In recent years more people are spending their discretionary income on health screening (i.e. to find out about their own health status) as a means of avoiding potential health problems by detecting such problems at their earliest stages. In the field of radiology, consumer demand for such health screening has resulted in the establishment of “Wellness Centers”, in which patient-clients may have thorough (e.g. whole body) screenings done as a means of early warning and identification of potential health hazards. Moreover, the advent of very fast, low cost, widely distributed CT scanners has made it possible to place such screening services within the reach of the general population. For example, modern CT scanners operate quickly, thus reducing the time of a complete whole body scan to about 30 mins. Accordingly, the recent advent of these Wellness Centers (in which radiology imaging is used for screening rather than diagnosis) have placed many new demands on the practice of Radiology. For instance, such Wellness Centers must operate with a patient-consumer focus, in which rapid turn around time and easily understandable (i.e.: patient readable) reporting are necessary. Since such Wellness Centers typically provide composite reporting of radiological screening of a number of different internal organs, they also require the management and reporting of a significant amount of data.

For example, performing such thorough screening (e.g.: whole body scans to identify health hazards at an early stage) has resulted in the generation of a significant amount of data which must be analyzed, compiled and presented to the patient in an easily understandable format. Consequently, rapid report turn around time is desired. Reporting results within minutes would be most desirable. However, in the past, it has proven difficult to compile and present such reports as quickly as would be desired.

Moreover, since Wellness Centers typically operate independently of hospitals, hospital transcription staff is typically not available to compile and generate a patient report. Accordingly, the high volume, short turn around time work produced at a Wellness Center has rendered the traditional hospital dictation-transcription method of producing a radiology report inadequate.

A further problem is that Radiology reports may be generated both at a hospital and at a Wellness Center or at multiple Wellness Centers. Accordingly, reports may unfortunately become scattered at multiple locations, making it increasingly difficult to compile and organize such reports for future reference.

A problem with Radiologists creating Radiology reports is that interruptions typically lead to inefficiency as the Radiologist must “start over” while preparing the report. To ensure that no organ is missed, the physician typically starts over at a “safe” organ (an organ that they are sure they have evaluated). What would instead be desirable is a system in which the physician could rapidly ascertain which organs have been reviewed and which organs are yet to be reviewed, such that the time lost by interruptions does not significantly delay the preparation of the final patient report.

Moreover, the manual typing of reports is both slow and cumbersome. This is true both when the report is being prepared by the Radiologist or by transcription staff.

An additional problem encountered in generating multi-organ (e.g. “whole body”) radiology reports is the complexity of generating a billing statement. This is due to that fact that such billing has required compiling information from to lists of the patients and lists of the exams performed on each of the individual patients and determining the amount due (i.e.: payment) for each type of exam. Compiling such billing statements can thus be very tedious. This has been an especially difficult task when reports were scattered at different sites.

### BRIEF SUMMARY OF THE INVENTION

In preferred aspects, the present invention provides a method of generating a patient report, comprising: presenting an operator with an on screen menu of standardized types of reports; having the operator select a standardized type of report from the on screen menu of standardized types of reports; presenting the operator with an on screen organ list corresponding to the selected standardized type of report; for each organ, presenting the operator with a menu of standard medical descriptions or diagnoses corresponding to the organ; having the operator determine a medical description or diagnoses corresponding to each organ; and outputting a patient report describing the medical description or diagnoses of each organ. In preferred aspects, the on screen menu is customizable to suit the Radiologists individual preferences.

In alternate preferred aspects, the present invention provides a computer system for generating a patient report, comprising: a system for presenting an operator with an on screen menu of standardized types of reports; a system for allowing the operator to select a standardized type of report from the on screen menu of standardized types of reports; a system for presenting the operator with an on screen organ list corresponding to the selected standardized type of report; a system for presenting the operator with a menu of standard medical descriptions or diagnoses corresponding to each organ; a system for allowing the operator to enter a medical description or diagnoses for each organ; and a system for outputting a patient report incorporating the medical descriptions or diagnoses for each organ.

In alternate preferred aspects, the present invention provides a computer user interface for generating a patient report, comprising: a first screen presenting an operator with a menu of selectable standardized types of reports; and a second screen presenting the operator with an on screen organ list corresponding to any of the selected standardized types of report, wherein a menu of selectable standard medical descriptions or diagnoses are provided for each of the organs. Preferably, either or both of the presentation and selection among standard report types and the presentation and selection among standard medical conditions or diagnoses for each organ is accomplished in pop-up (point and click) window format.

An advantage of the present invention is that it provides an operator with a choice among various standardized types of reports. For example, in preferred aspects, such standardized report types may comprise: (a) Male Chest, Abdomen and Pelvis CT, (b) Male Brain, Chest, Abdomen and Pelvis CT, (c) Female Chest, Abdomen and Pelvis CT, (d) Female Brain, Chest, Abdomen and Pelvis CT, (e) Virtual Colonoscopy, (f) Coronary Scoring, (g) Coronary Scoring with Consult, (h) Chest CT, (i) Abdomen CT, (j) Chest and Abdomen CT, (k) Male Abdomen and Pelvis CT; and (l) Female Abdomen and Pelvis CT. It is to be understood, however, that the above list is merely exemplary and that other standard medical reports can be used. Preferably, the standardized report types are provided in an on-screen pop-up menu, and the physician easily selects the standardized report type by a mouse point and click operation.

After a particular report type has been selected, the present invention then displays a list of organs corresponding specifically to the report type selected. This is particularly advantageous in that non-appropriate body parts are not displayed. For example, if the operator selects a “Male Pelvis” exam, organs such as “uterus” and “ovaries” will not be displayed. Similarly, if the operator selects a “Female Pelvis” exam, the “prostate” will not be displayed. Accordingly, the displayed organ list corresponding to the selected report type need only comprise a subset of all the organs which are included in various standardized report types. This important “organ specific” feature of the present invention has many advantages.

First, the present “organ specific” display system ensures that every organ which is to be included in the scan is displayed to the operator. Most preferably, every relevant organ is displayed on a single computer screen at the same time. This ensures that the physician visually takes note of each of the organs, and (as will be further described) enters a description of the medical condition (i.e.: a “diagnosis”) for each organ. In this way, no organ is inadvertently missed when generating the patient report. Thus, an important advantage of this feature of the invention is that it provides a “whole body” approach such that various organs are not inadvertently missed by the radiologist preparing the report. Stated another way, it is very unlikely that a physician operating the present invention could inadvertently miss an organ since a missed organ would remain prominently displayed with a “blank” medical description next to it on the computer screen.

Secondly, the present “organ specific” display system ensures that any organ which is not to be included in the selected report is not displayed for the operator. This eliminates “clutter” or distraction on the computer screen. Therefore, the operator will instead focus on the displayed organs. Again, this will ensure that no relevant organ (which is to be included in the selected type of standardized report) is missed and that an organ which is inappropriate for the exam or gender is not accidentally reported. Optionally, the present invention may provide a feature in which the final report can not be generated until a description of each of the displayed organs is completed by the Radiologist.

In a preferred aspect, the present invention displays the complete organ list on a single computer screen. As such, it is not necessary to “tab” or “toggle” between various computer screens when entering a description of the medical conditions (e.g.: when selecting or composing the “diagnosis”) of the organs of the various organs on the list. This has the additional advantage of providing a survey view of all organs for easy summarization in the free text impression (“custom diagnosis”) section.

In accordance with the present invention, for each organ displayed, a menu of standard medical conditions (e.g. “diagnoses”) is also automatically provided. For example, for the organ “lungs”, a selection of standard medical descriptions, will be displayed. Such standard medical descriptions may include: (a) “Normal”; (b) “Mild centrilobular emphysema is noted”; (c) “Moderate centrilobular emphysema is noted”; (d) “Marked centrilobular emphysema is noted”; (e) “Minimal scarring is seen in both apices”; and (f) “Minimal scarring is seen in both lung bases”. It is to be understood, however, that the above list is merely exemplary and that other standard medical conditions (i.e.: diagnoses) can also/instead be used.

In accordance with various aspects of the present invention, the operator/radiologist may then either select one of these standard medical descriptions which has been provided, edit one of the standard medical descriptions which has been provided, add new standard medical descriptions, edit the list of standard medical descriptions, or compose an alternate medical description. Preferably, for each organ, the standard medical descriptions are provided in a pop-up menu, and the physician selects one of the standard medical descriptions by a mouse point and click operation. As such, an advantage of the present invention is that it provides a rapid point and click user interface.

Additional advantages of the present invention include the fact that it eliminates dictation, and significantly reduces the need to type.

In an additional aspect, patient billing is automated. Billing for the Radiologists is automatically determined by information provided during the creation of the reports. The system knows the date of the report, the type of exam performed, and the name of the Radiologist reporting the exam. Also, as part of the configuration, the system is told how much should be billed for the reading of each exam. From this information, the invention is able to calculate an accurate billing statement instantaneously and on-demand.

In preferred aspects, entering a new patient record, finding an existing patient record by name or date, listing patient records and billing may all be performed from an initial single computer screen “front page” user interface.

### BRIEF DESCRIPTION OF THE DRAWINGS

FIG. 1 is a screen shot of the opening screen of the present invention, prior to selecting a patient.

FIG. 2 is a screen shot of the individual patient screen of the present invention after a patient has been selected, but prior to selecting a standardized exam type.

FIG. 3 is a screen shot similar to FIG. 2, but showing a pop-up menu for selecting a standardized type of report.

FIG. 4 is a screen shot displayed after a particular type of standardized type of report has been selected.

FIG. 5 is a close up menu of exemplary standard medical conditions (i.e.: diagnoses) corresponding to the “lungs”.

FIG. 6A is a dialog box which is displayed when the operator is composing a suitable medical description of the organ.

FIG. 6B is a dialog box which is displayed when the operator is editing a previously entered medical description of the organ.

FIG. 7 is a dialog box which is displayed when the operator is editing the menu of standard medical conditions for an organ.

FIG. 8 is a screen shot of searching for a patient's record by name.

FIG. 9 is a screen shot of searching for a patient's record by date.

FIG. 10 is a screen shot of searching for a billing record by date.

### DETAILED DESCRIPTION OF THE INVENTION

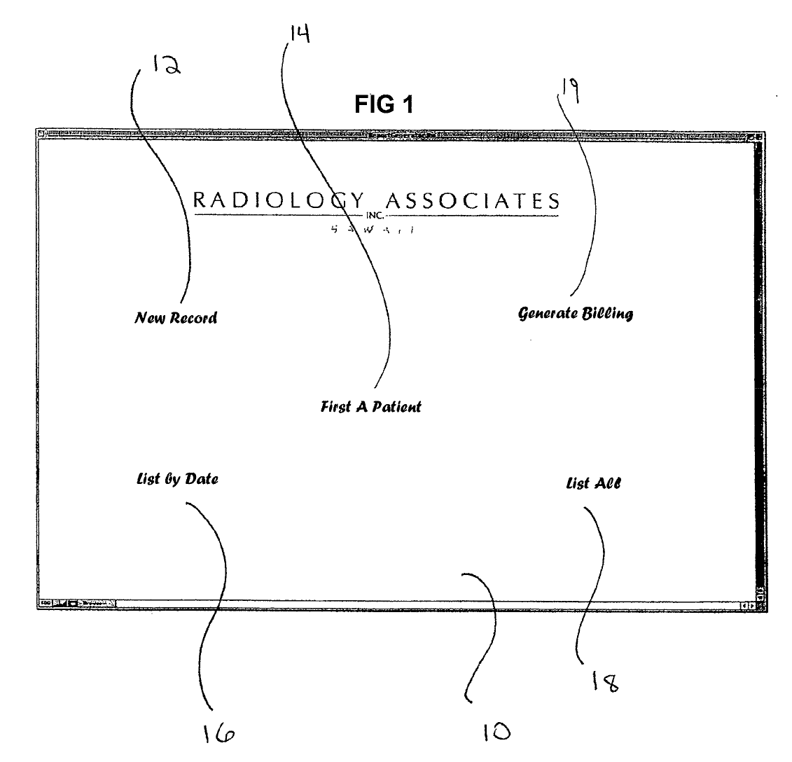

FIG. 1 illustrates an exemplary embodiment of the opening screen/user interface of the present invention. Screen 10 is displayed for the operator/radiologist. In preferred aspects, the operator may select among the following functions: “enter a new record” (i.e.: add a new report) 12; “find a patient” 14; “list by date” 16; “list all” 18; and “generate billing” 19. Preferably, selection among functions 12, 14, 16, 18 and 19 is performed by a single mouse click.

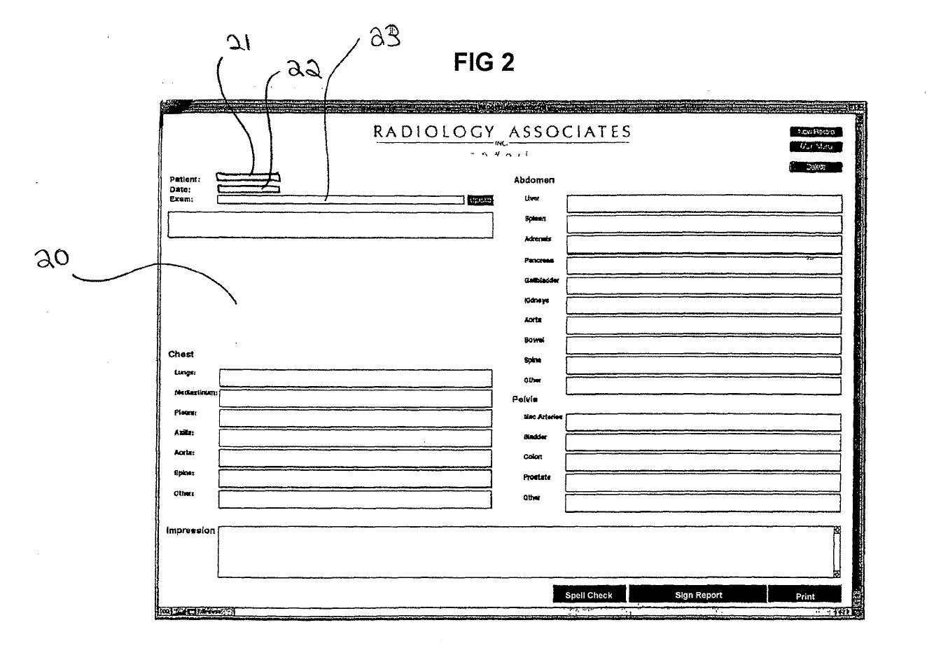

Clicking on function 12 (i.e. “enter a new record”) results in the display of computer screen 20 (as illustrated in FIG. 2). In field 21, the operator enters the patient's name. In field 22, the operator enters the date. The information entered in fields 21 and 22 is preferably stored in a database format, and can be used in future retrieval of patient records. In various options, fields 21 and 22 can be reached either by mouse click or by hitting the “tab” button on the computer keyboard.

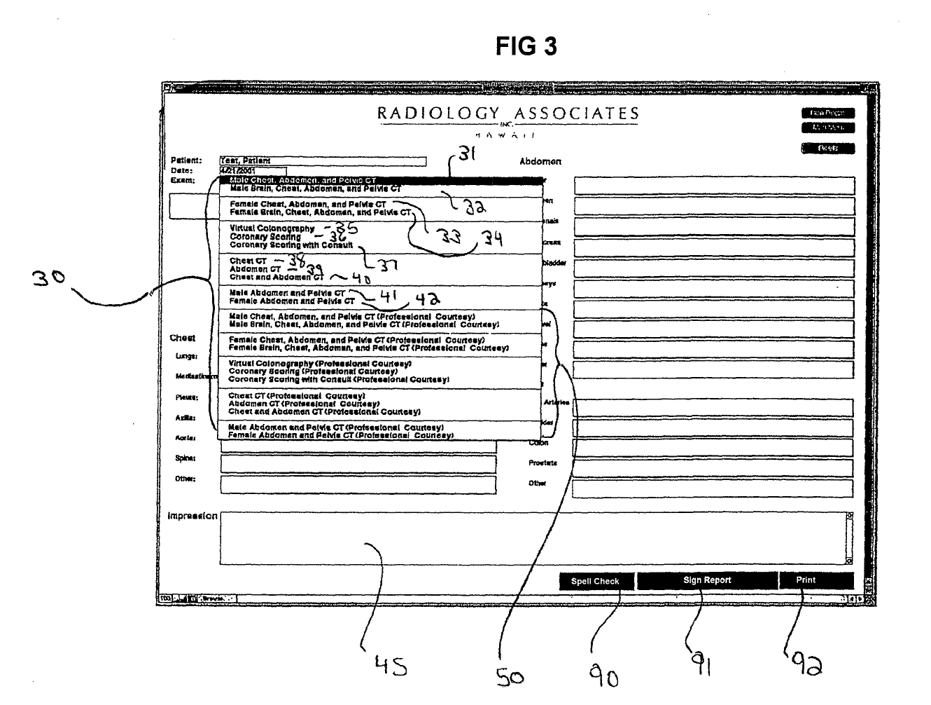

In field 23, the operator selects which type of standard report is desired. Most preferably, a pop-up menu will be displayed when the operator enters field 23. An exemplary pop-up menu 30 which appears in field 23 is displayed in FIG. 3. Menu 30 offers the operator a variety of choices among standard medical reports. For example, (and without limiting the present invention thereto) the operator may select among the following reports: Report 31 (Male Chest, Abdomen and Pelvis CT); report 32 (Male Brain, Chest, Abdomen and Pelvis CT); report 33 (Female Chest, Abdomen and Pelvis CT; report 34 (Female Brain, Chest, Abdomen and Pelvis CT); report 35 (Virtual Colonoscopy); report 36 (Coronary Scoring); report 37 (Coronary Scoring with Consult); report 38 (Chest CT); report 39 (Abdomen CT); report 40 (Chest and Abdomen CT); report 41 (Male Abdomen and Pelvis CT) and report 42(Female Abdomen and Pelvis CT).

In optional preferred aspects, the operator may instead select any of the “Professional Courtesy” reports 50 corresponding to each of the above listed reports. The selection of such Professional Courtesy reports 50 operates identically to the selection of any of reports 31 to 42, with the sole difference being that the present invention's billing function will record a $0.00 billing for the exam report.

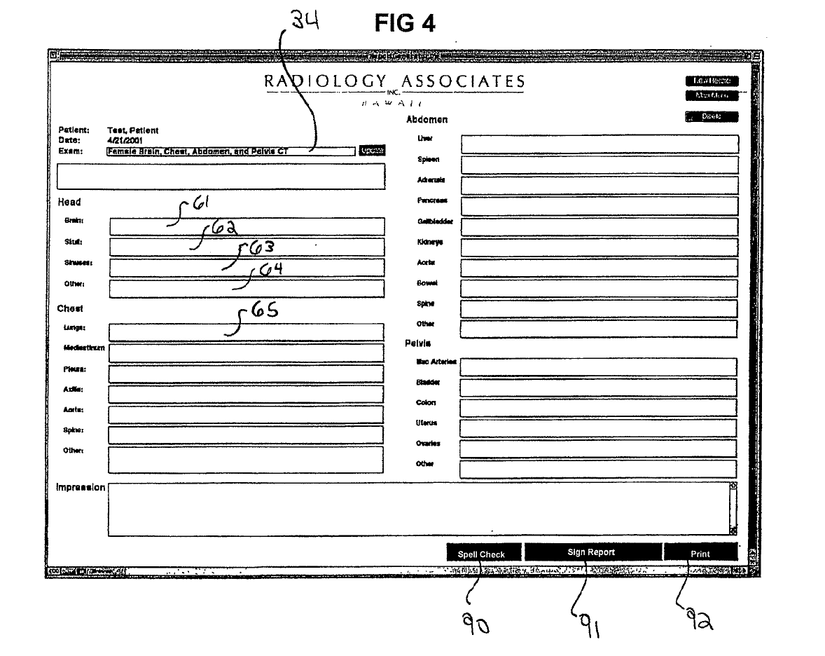

After the operator has selected a desired standard report type (31 to 42 or 50) from menu 30, a screen displaying all of the organs corresponding to such a scan is displayed. An example of such a screen is shown in FIG. 4. Specifically, the screen shown in FIG. 4 is displayed when an operator selects report 34 (i.e.: Female Brain, Chest, Abdomen and Pelvis CT).

An important advantage of the present screen layout is that all of the organs which are to be included in the desired final standard report may be displayed on one screen at one time. Moreover, any organs which are not to be included on the desired final standard report are removed. For example, the display of “uterus” and “ovaries” are removed when any of “male” reports 31, 32 or 41 are selected.

This feature of the present invention permits an operator to see at a glance whether diagnoses or medical descriptions of all desired organs have been completed. If the operator/radiologist is distracted mid-way through filling out the data used to make the final report,(s)he can quickly glance back at the computer screen and see which organs have been completed, and which still need to be completed, as will be explained.

As shown in FIG. 4, after the operator has selected a report (for example, report 34), a list of separate fields (61, 62, 63, 64, 65, etc.) corresponding to each organ is displayed. Fields (61, 62, 63, 64, 65, etc.) preferably are grouped together anatomically. This preferred feature of the invention allows for the reviewer to select the most important findings to summarize in the impression of the report. For example, the brain (field 61), skull (field 62), sinuses (field 63) can all be displayed together under the grouping “Head”. Similar groupings are possible for each of the “Chest”, “Abdomen” and “Pelvis”. In preferred aspects, the computer mouse or “tab” key can be used to move among each of fields 61, 62, etc.

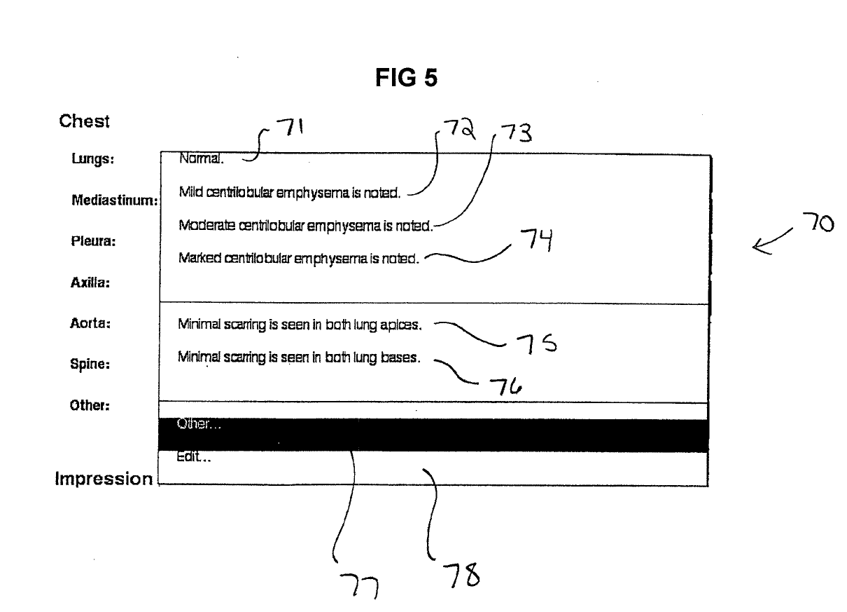

FIG. 5 shows an exemplary pop-up menu 70 which is displayed when the operator selects field 65 (i.e.: “lungs”) in FIG. 4. Menu 70 comprises a number of different standard medical descriptions (e.g.: diagnoses) corresponding to the particular organ (e.g. lungs) which has been selected. In accordance with the present invention, the operator may (point-and-click) select any of the standard medical descriptions conveniently provided for the organ. For example, in the case of “lungs”, the operator may select among condition 71 (“Normal”); condition 72 (“Mild centrilobular emphysema is noted”); condition 73 (“Moderate centrilobular emphysema is noted”); condition 74 (“Marked centrilobular emphysema is noted”); condition 75 (“Minial scarring is seen in both apices”); and condition 76 (“Minimal scarring is seen in both lung bases”). It is to be understood, however that these medical conditions are merely exemplary. Other medical conditions or diagnoses may be selected as well. In optional preferred aspects, such menu choices may be customized by the operator. By selecting a particular medical condition (71 to 76) the operator may thus “select” a description or diagnosis. It is to be understood that as used herein, the “description” of an organ may comprise a description of its “status” or a “diagnosis” optionally suggesting a potential treatment for the organ.

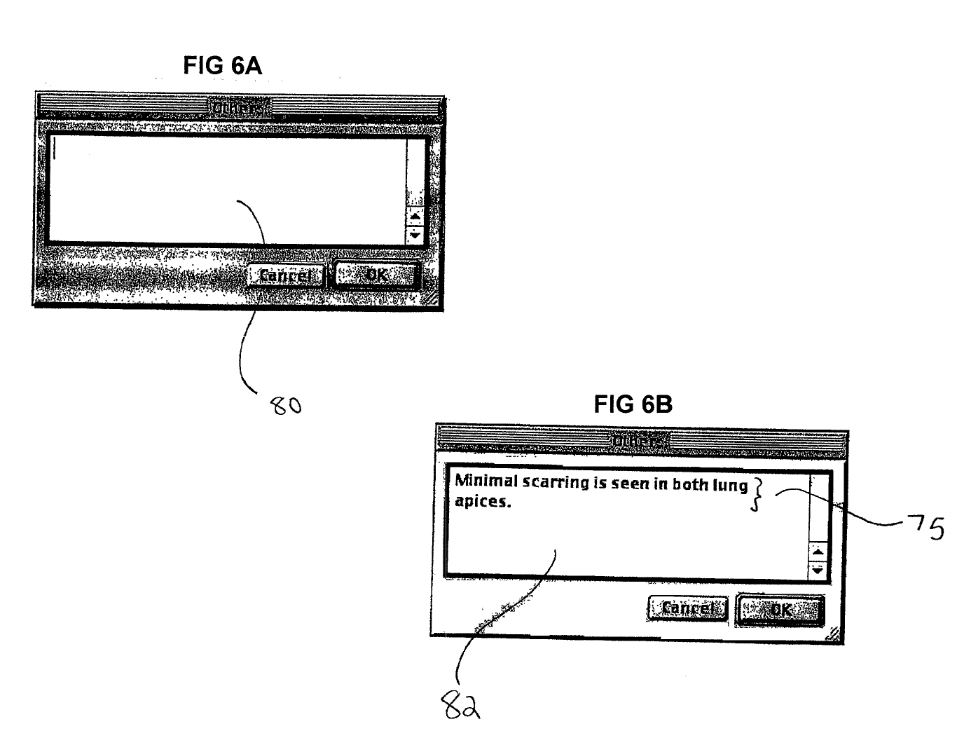

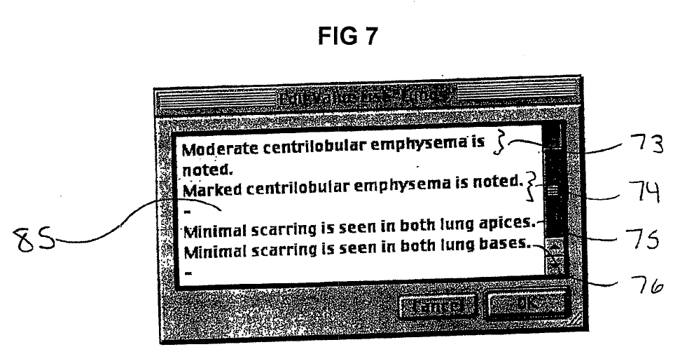

In additional aspects, the operator may also “compose” a custom diagnosis of the medical condition. For example, the operator may select condition 77 “other”. When 77 has been selected, the operator may then be presented with a blank dialog box 80 (FIG. 6A) in which the operator may type a non-standard description. In an alternate aspect of the invention, the operator may first select a standard medical diagnosis (e.g.: condition 75) and then select condition 77 (e.g. other). When this operation is performed, a dialog box 82 (FIG. 6B) will appear in which the text corresponding to condition 75 is displayed for operator editing. Selection of condition 78 (i.e. “edit”) in Fig. will permit the operator to edit the standard text corresponding to each of conditions 71 to 76 or to add a new custom condition. An example of the dialog box 85 presented for performing such editing is displayed in FIG. 7.

In preferred aspects, the various medical descriptions may be standardized across various report types. For example, the same medical descriptions (e.g.: 71 to 76) which correspond to the “lungs” (i.e. field 65) can be presented to the operator in each of the reports which comprise the organ “lungs” (e.g.: reports 31 to 34, 38 and 40).

A first advantage of this feature of the invention is that the operator need not waste time repeated typing standard medical descriptions which tend to be used again and again for various patients.

A second advantage of this feature of the invention is that it is difficult for the operator to miss an organ, since the field corresponding to the organ remains noticeably blank until appropriate text (describing the medical condition of the organ) is either selected or composed.

Returning to FIG. 3, an optional “impression” (free text) field 45 may be provided. In this “impression” field 45, the operator may freely enter any text, as desired. A first advantage of such a field is that the operator has a place in which to describe any “overall” patient impressions, or enter any additional non-standard medical descriptions. A second advantage of such an “impression” field 45 is that it may preferably be displayed on the same single computer screen on which all of the patient organs are displayed. Therefore, the operator can simultaneously view the medical descriptions of all of the organs in the scan (simultaneously on a single computer screen) at the same time that (s)he is composing the text in the “impression” field 45. This is expected to yield a more accurate overall patient impression. Specifically, in the absence of the present invention, the operator would instead be viewing, at best, only a few of the organs when composing an overall “impression” or “conclusion” type of observation. The operator might then either forget the diagnosis corresponding to some of the earlier described organs. Thus, the physician's impressions would tend to reflect the “last viewed” organs.

As illustrated in FIGS. 2, 3 and 4, after the medical descriptions have been entered for each of the organs (i.e. after a medical description or diagnosis has been selected or composed for each organ) the operator may then “spell-check” (selection 90); “sign with a DR's name selected from a database” (selection 91); or “print” the final report (selection 92).

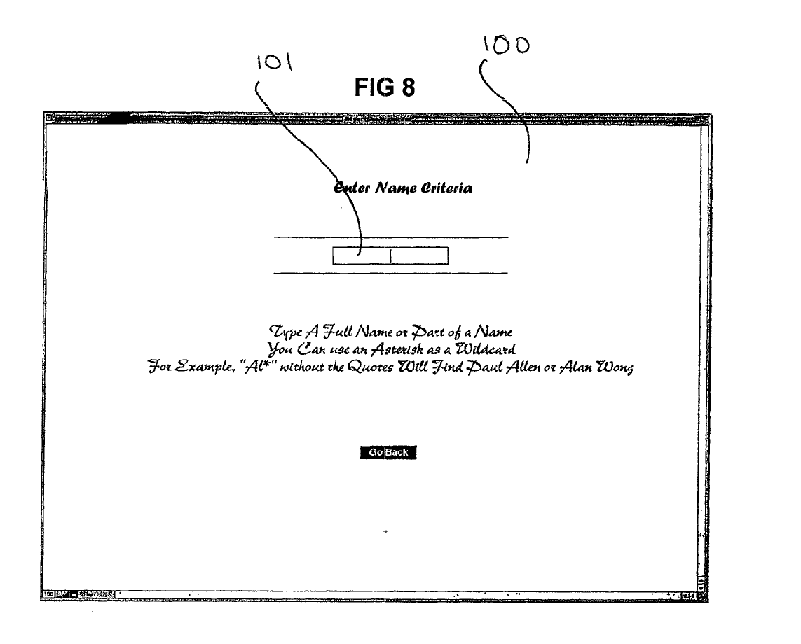

Returning to FIG. 1, optional functions 14, 16, 18 and 19 may also be used as follows: Selection 14 (i.e.: “find a patient”) displays screen 100 (FIG. 8) which provides the operator with the option of finding a patient record corresponding to a name entered in box 101.

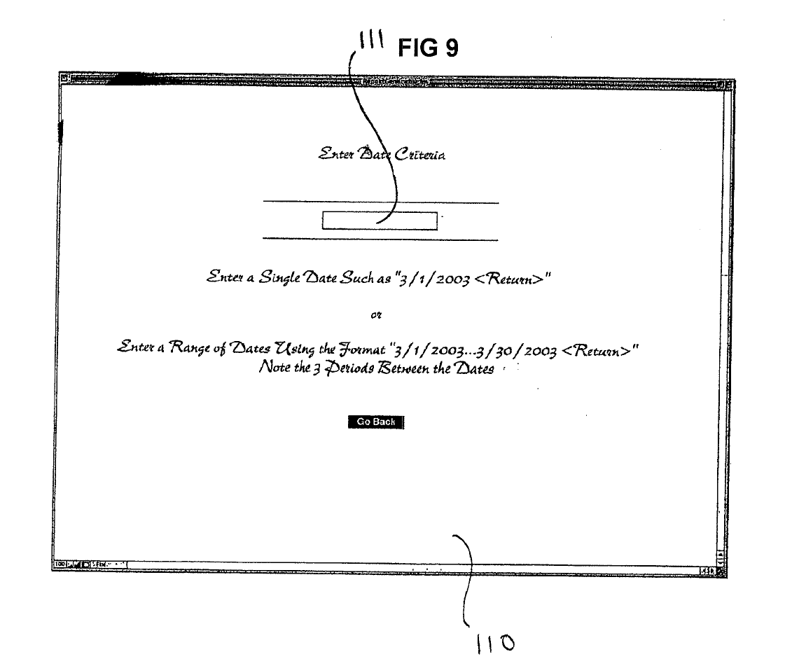

Selection 16 (i.e.: “list by date”) displays screen 110 (FIG. 9) which provides the operator with the option of finding patient records corresponding to a date (or date range) entered in box 111.

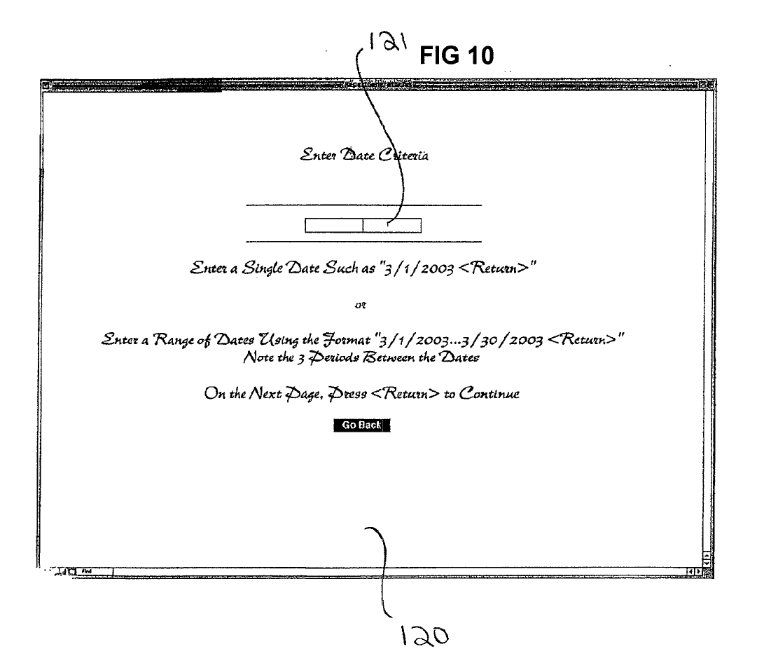

Selection 18 (i.e.: “list all”) displays screen 120 (FIG. 10) which provides the operator with the option of generating a billing report corresponding to a date or date range entered in box 121.

What is claimed is:

1. A computer implemented method of generating a patient report, the computer implemented method comprising:
electronically retrieving a medical image over a network by a computer from a database, the medical image comprising a subset of organs, wherein a scanning device generated the medical images by scanning a selected patient body section corresponding to the subset of organs;
electronically accessing by the computer a database comprising a plurality of report types, wherein said accessing occurs over the network;
electronically causing by the computer to present a list of radiology report types, each radiology report type corresponding to the subset of organs;
electronically receiving in the computer selection information indicative of a selected report type, the selected report type being associated with the subset of organs and a billing code;
for the selected report type:
electronically causing to present by the computer an organ list based at least on the subset of organs imaged by the scanning device and the selected report type, wherein the organ list is electronically presented on a single screen;
electronically causing to present by the computer for each organ in the subset of organs a list of applicable medical descriptions;
electronically receiving in the computer a selected applicable medical description, wherein the selected applicable medical description is associated with each organ;
electronically causing by the computer an outputting of a patient report comprising the medical descriptions of the associated organs in the selected report type; and
electronically causing by the computer an outputting of a billing statement based at least on the billing code associated with the subset of organs.

2. A method of generating a patient report, comprising:
presenting a list of report types, each report type corresponding to a body section imaging procedure;
receiving selection information indicative of a selected report type, the selected report type being associated with a plurality of organs imaged by a CT scan of the body section corresponding to the selected report type;
for the selected report type:
presenting an organ list of the associated organs imaged by a scan of the body section corresponding to the selected report type; and
for each associated organ, presenting a list of applicable medical descriptions and receiving a selected applicable medical description, wherein the selected applicable medical description is associated with each associated organ; and
outputting a patient report comprising the medical descriptions of the associated organs in the selected report type.

3. The method of claim 2, wherein the steps of receiving a selected applicable medical description includes receiving input from an operator.

4. The method of claim 2, further comprising receiving a composed medical description and associating the composed medical description to one of the associated organs corresponding to the selected report or transmitted electronically.

5. The method of claim 4, wherein receiving a composed medical description includes editing a standard medical description.

6. The method of claim 4, wherein receiving a composed medical description includes receiving a user provided description.

7. The method of claim 2, wherein the list of report types is presented in a pop-up menu.

8. The method of claim 3, wherein the list of applicable medical descriptions is presented in a pop-up menu.

9. The method of claim 2, wherein outputting a patient report includes printing out the patient report.

10. The method of claim 2, wherein outputting a patient report comprises displaying the patient report on a computer screen.

11. The method of claim 2, wherein the organ list is presented in its entirety on a screen.

12. The method of claim 2, further comprising generating a billing report associated with the selected report.

13. A computer system for generating a patient report, comprising:
a system configured to display an on-screen menu comprising a list of report types, each report type corresponding to a body section scan;
a system configured to receive selection information indicative of a selected report type, the selected report type being associated with a plurality of organs imaged by a scan of the body section corresponding to the selected report type;
for the selected report type:
a system configured to display an on-screen organ list of the associated organs imaged by the scan of the body section corresponding to the selected report type and to display a list of applicable medical descriptions for each associated organ; and
a system configured to receive information indicative of a medical description for at least one of the associated organs corresponding to the selected report type; and
a system configured to output a patient report comprising the medical descriptions of the associated organs in the selected report type.

14. The computer system of claim 13, wherein the system configured to receive information indicative of a medical description is further configured to permit an operator to select one of the standard medical descriptions for each organ.

15. The computer system of claim 14, wherein the system configured to display an on-screen organ list of organs associated with a report type is further configured to display the applicable medical descriptions in a pop-up menu.

16. The computer system of claim 13, wherein the system configured to display an on-screen menu comprising a list of report types is further configured to receive from a user a composed medical description for one of the associated organs.

17. The computer system of claim 1, wherein the computer comprises a plurality of computers connected through the network.

18. The computer system of claim 13, wherein the on-screen organ list of associated organs is displayed in its entirety on a single computer screen.

19. The computer system of claim 13, further comprising a system configured to generate a billing report of the associated organs corresponding to the selected report type, wherein a billing entry is made for each of the associated organs.

20. The computer system of claim 13, wherein the list of organs in the patient report comprises a subset of an organ list corresponding to the report type.
